(19) United States
(12) Patent Application Publication
(10) Pub. No.: US 2009/0058834 A1
(43) Pub. Date: Mar. 5, 2009

(54) APPARATUS AND METHOD FOR INPUTTING LETTERS

(75) Inventor: Mi-kyung KIM, Yongin-si (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Suwon-si (KR)

(21) Appl. No.: 12/105,383

(22) Filed: Apr. 18, 2008

(30) Foreign Application Priority Data
Aug. 31, 2007 (KR) 10-2007-0088601

(51) Int. Cl. G06F 3/033

(52) U.S. Cl. 345/184

(57) ABSTRACT

User input apparatus and method for inputting letters. The letters can be input based on the rotations of the user input apparatus. By inputting the letters in the differentiated manipulation not depending on the buttons, the diversity and the convenience in inputting the letters can be achieved.

### CROSS-REFERENCE TO RELATED APPLICATIONS

This application claims priority from Korean Patent Application No. 10-2007-88601 filed on Aug. 31, 2007 in the Korean Intellectual Property Office, the entire disclosure of which is incorporated herein by reference.

### BACKGROUND OF THE INVENTION

1. Field of the Invention

Apparatuses and methods consistent with the present invention relate generally to a user input, and more particularly, to a user input apparatus for inputting letters and a method thereof

2. Description of the Related Art

Using an electronic device such as television, a user command may be input by manipulating buttons of a remote controller. In doing so, the button manipulation can cause discomfort or inconvenience to users.

Recently, a number of functions of electronic devices is increasing in accordance with multiple functions of the electronic devices. Since one function is designated to one button in general, the multifunction of the electronic device leads to the increasing number of the buttons in the remote controller.

Particularly, bidirectional electronic devices such as Internet Protocol Television (IPTV) provide increasing transmission and increasing transmission opportunity with respect to letter transmission in various ways. If the letters are input by manipulating the buttons of the remote controller, the user is highly likely to experience inconvenience.

Therefore, what is needed is a method for inputting a user command more easily and efficiently without the button manipulation.

### SUMMARY OF THE INVENTION

Exemplary embodiments of the present invention address at least the above problems and/or disadvantages and other disadvantages not described above. Also, the present invention is not required to overcome the disadvantages described above, and an exemplary embodiment of the present invention may not overcome any of the problems described above.

An aspect of the present invention has been provided to solve the above-mentioned and/or other problems and disadvantages and an aspect of the present invention provides a user input apparatus and method for inputting letters using other manipulation than the button manipulation to provide diversity and convenience in inputting the letters.

According to an exemplary aspect of the present invention, there is provided a user input apparatus including a first input unit which is rotated by a manipulation of a user to input a plurality of letters of an enumeration type language through a plurality of rotations and to input one of the letters through one rotation; and a controller which controls to overlap and display a mark with one of the displayed letters based on the rotation of the first input unit.

The user input apparatus may further include a first display which enumerates the letters and displays the mark indicating one of the letters.

The user input apparatus may further include a second input unit which is rotated according to the manipulation of the user. When the user rotates the second input unit in a first direction, the controller may control to select the letter overlapped with the mark and to rearrange the letters in an area of the first display around the selected letter.

The user input apparatus may further include a third input unit which is rotated by the manipulation of the user. When the user rotates the third input unit in a second direction, the controller may control to enumerate words including at least one of the selected letters in the first display.

The words may start with at least one of the selected letters.

The controller may control to display the letters by distinguishing the at least one selected letter from the unselected letters using at least one of a color, a size, a font, a underline, and a shadow.

The first input unit may be pressed by the user, and when the user presses the first input unit, the controller may control to select the letter overlapped with the mark among the letters enumerated in the first display and to rearrange the letters around the selected letter in the area of the first display.

The first input unit comprises a wheel. When the user presses the wheel, the controller may control to display the at least one selected letter in the first display.

The letters may vertically move in the first display.

A rotation direction of the first input unit rotated by the user may be the same as an enumeration direction of the letters.

The user input apparatus may further include a transmission input unit for sending a word or a sentence generated using the enumerated letters to an external device.

The user input apparatus may further include a second display for displaying a word or a sentence generated using the enumerated letters. The first display and the second display may be positioned in different areas of one display device.

According to another exemplary aspect of the present invention, there is provided a user input method including rotating a first input means by a manipulation of a user, the first input means for inputting a plurality of letters of an enumeration type language through a plurality of rotations and inputting one of the letters through one rotation; and overlapping and displaying a mark with one of the displayed letter based on the rotation of the input means.

The user input method may further include when a second input means which is rotated by the manipulation of the user turns in a first direction, selecting the letter overlapped with the mark and rearranging the letters in an area around the selected letter.

The user input method may further include when a third input means rotated by the manipulation of the user turns in a second direction, enumerating words including the at least one selected letter.

The words may start with the at least one selected letter.

The displaying operation may distinguish the at least one selected letter from the unselected letters using a color, a size, a font, an underline, and a shadow.

The user input method may further include when the user presses the first input means, selecting a letter overlapped with the mark among the enumerated letters and rearranging the letters in an area around the selected letter.

The user input method may further include when the user presses a wheel of the first input means, displaying the at least one selected letter.

The letters may be displayed to vertically move.

A rotation direction of the first input means rotated by the user may be the same as an enumeration direction of the letters.

The user input method may further include sending a word or a sentence generated using the enumerated letters to an external device.

The user input method may further include displaying a word or a sentence generated using the enumerated letters. A display showing the mark indicating one of the letters and a display showing the word or the sentence completed by arranging the input letters may be positioned in different areas of one display device.

According to another exemplary aspect of the present invention, there is provided a user input apparatus including a first input unit which is rotated by a manipulation of a user; a second input unit which is rotated by a manipulation of the user; a third input unit which is rotated by a manipulation of the user; and a controller which selects one of consonants enumerated in a display as an initial based on the rotation of the first input unit, selecting one of vowels enumerated in the display as a medial based on the rotation of the second input unit, and selecting one of consonants enumerated in the display as a final based on the rotation of the third input unit.

A rotation direction of the first input unit, a rotation direction of the third input unit, and an enumeration direction of the consonants may be the same, and a rotation direction of the second input unit and an enumeration direction of the vowels may be the same.

The controller may control to display a letter combining at least one of the selected initial, medial and final in an overlapping area of areas enumerating the consonants and the vowels.

At least one of the first input unit, the second input unit, and the third input unit may rotate the consonants or the vowels using a wheel.

A letter input by pressing a wheel of the second input unit may include an initial and a medial, and a letter input by pressing a wheel of the third input unit may include an initial, a medial, and a final.

According to another exemplary aspect of the present invention, there is provided an input method including selecting one of consonants enumerated in a display as an initial based on a rotation of a first input unit which is rotated by a manipulation of a user; selecting one of vowels enumerated in the display as a medial based on a rotation of a second input unit which is rotated by a manipulation of the user; and selecting one of consonants enumerated in the display as a final based on a rotation of a third input unit which is rotated by a manipulation of the user.

A rotation direction of the first input unit, a rotation direction of the third input unit, and an enumeration direction of the consonants may be the same, and a rotation direction of the second input unit and an enumeration direction of the vowels may be the same.

The input method may further include displaying a letter combining at least one of the selected initial, medial and final in an overlapping area of areas enumerating the consonants and the vowels.

At least one of the first input unit, the second input unit, and the third input unit may rotate the consonants or the vowels using a wheel.

The input method may further include when a wheel of the second input unit is pressed, inputting a letter comprising an initial and a medial; and when a wheel of the third input unit is pressed, inputting a letter comprising an initial, a medial and a final.

### BRIEF DESCRIPTION OF THE DRAWINGS

The above and/or other aspects of the present invention will be more apparent by describing certain exemplary embodiments of the present invention with reference to the accompanying drawings, in which:

FIG. 1 is a block diagram of a user input apparatus according to an exemplary embodiment of the present invention;

FIG. 2 is a flowchart of an input method according to an exemplary embodiment of the present invention;

FIGS. 3A through 3D depict an English input method according to an exemplary embodiment of the present invention; and

FIGS. 4A, 4B and 4C depict a Korean input method according to an exemplary embodiment of the present invention.

### DETAILED DESCRIPTION OF EXEMPLARY EMBODIMENTS OF THE INVENTION

Certain exemplary embodiments of the present invention will now be described in greater detail with reference to the accompanying drawings.

In the following description, same drawing reference numerals are used for the same elements even in different drawings. The matters defined in the description, such as detailed construction and elements, are provided to assist in a comprehensive understanding of the invention. Thus, it is apparent that the present invention can be carried out without those specifically defined matters. Also, well-known functions or constructions are not described in detail since they would obscure the invention with unnecessary detail.

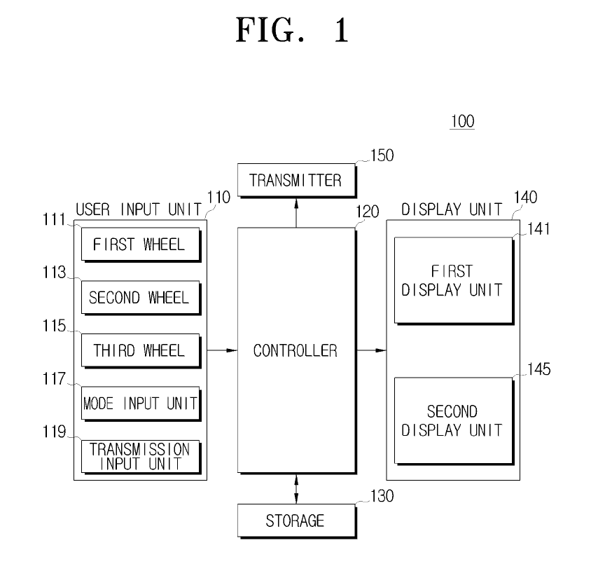

FIG. 1 is a block diagram of a user input apparatus 100 according to an exemplary embodiment of the present invention. The user input apparatus 100 of FIG. 1 comprises a user input unit 110, a controller 120, a storage 130, a display unit 140, and a transmitter 150.

The user input unit 110 receives a user command for inputting letters. The user input unit 110 comprises a first input unit, a second input unit, a third input unit, a mode input unit 117, and a transmission input unit 119. In this exemplary embodiment, the first input unit comprises a first wheel 111, the second input unit comprises a second wheel 113, and the third input unit comprises a third wheel 115.

The mode input unit 117 selects a mode for inputting a letter. In particular, the mode input unit 117 receives a user's command and allows to select a user's intended mode, for example, an English input mode or a Korean input mode. When the user manipulates the mode input unit 117, the English input mode is changed to the Korean input mode or vice versa.

The first wheel 111, the second wheel 113, and the third wheel 115 are used to input the corresponding letters in the mode selected at the mode input unit 117. When the user rotates the wheel, a signal according to the rotation is input to the controller 120.

In the mode selected at the mode input unit 117, the transmission input unit 119 sends the letters input through the first wheel 111, the second wheel 113, and the third wheel 115 to an external video device (not shown).

In more detail, upon actuating the transmission input unit 119, the signal of the transmission input is fed to the controller 120 and the controller 120 outputs the letters generated using the mode input unit 117, the first wheel 111, the second wheel 113, and the third wheel 115 to the transmitter 150.

The storage 130 stores letters arranged in the display in the English input mode, letters arranged in the display in the Korean input mode, and English words automatically arranged in the display in the English input mode.

When the user selects a letter input using the first wheel 111, the second wheel 113, and the third wheel 115, the controller 120 displays the letters and the words stored by the storage 130 in a first display unit 141.

The display unit 140 receives the user command signal for the letter input from the controller 120 and displays the letter according to the user's command. The display unit 140 comprises the first display unit 141 and a second display unit 145.

The first display unit 141 displays how the letters are completed according to the manipulations of the first wheel 111, the second wheel 113, and the third wheel 115.

More specifically, in the English input mode, the first display unit 141 displays English letters based on the rotations of the first wheel 111 and the second wheel 113 and displays words starting with the displayed English letters based on the rotation of the third wheel 115.

In the Korean input mode, the first display unit 141 displays Korean consonants based on the rotation of the first wheel 111, displays vowels based on the rotation of the second wheel 113, and displays consonants based on the rotation of the third wheel 115.

The second display unit 145 displays the completed letters or word as input by the first wheel 111, the second wheel 113, and the third wheel 115.

Specifically, the second display unit 145 displays the word completed in the English input mode as input by the first wheel 111, the second wheel 113, and the third wheel 115.

The second display unit 145 displays the letter completed in the Korean input mode as input by the first wheel 111, the second wheel 113, and the third wheel 115.

The transmitter 150 is operated by the transmission input unit 119 to receive the completed letters or word as input by the first wheel 111, the second wheel 113, and the third wheel 115 from the controller 120 and send it to the external video device.

The controller 120 controls by receiving a signal of the user command output by the user input unit 110.

When the user selects the English input mode using the mode input unit 117, the controller 120 controls to enumerate the English letters in the first display unit 141 in the vertical direction. When the user selects the Korean input mode, the controller 120 controls to show the consonant line and the vowel line in the first display unit 141.

Typically, the language system can be classified into an enumeration type language which generates words and sentences by enumerating letters such as English alphabets, and a combination type language which generates words and sentences by combining the letters such as Korean alphabets to generate one syllable and arrange the syllables.

Now, the operations of the controller 120 are described first in the English input mode which is the enumeration type language and then in the Korean input mode which is the combination type language.

In the English input mode, the controller 120 controls to overlap a mark with one of the letters displayed in the first display unit 141 based on the rotation of the first wheel 111, to select the letter overlapped with the mark based on the rotation of the second wheel 113, and to rearrange the letters around the selected letter.

Rather than to select the letter overlapped with the mark based on the rotation of the second wheel 113, the controller 120 may control to select the letter overlapped by the mark based on pressing of the first wheel 111.

When at least one letter is selected by repeating the above process using the first wheel 111 and the second wheel 113, the controller 120 controls to enumerate English words starting with the selected letters in the first display unit 141 based on the rotation of the third wheel 115.

In doing so, the controller 120 can control to display the selected letters in different color, size, and font from the unselected letters, to underline the selected letters, or to shade the selected letters.

When one of the listed English words based on the rotation of the third wheel 115 is selected, the controller 120 sends the selected word to the second display unit 145.

The controller 120 also controls a scrolling or rotation speed of the displayed letters and words according to the user's manipulation speed of the first wheel 111, the second wheel 113, and the third wheel 115.

When the user rotates the first wheel 111, the second wheel 113, and the third wheel 115 fast, the controller 120 controls to rapidly scroll and enumerate the letters and the words in the display unit 140. When the user rotates the first wheel 111, the second wheel 113, and the third wheel 115 slow, the controller 120 controls to slowly scroll and enumerate the letters and the words in the display unit 140.

In the Korean input mode, the controller 120 controls to select one of the displayed consonants as the initial based on the rotation of the first wheel 111, to select one of the displayed vowels as the medial based on the rotation of the second wheel 113, and to select one of the displayed consonants as the final based on the third wheel 115.

The controller 120 controls to display the letter of the initial, the medial, and the final in the overlapping area of the enumerated consonants and the enumerated vowels.

The controller 120 controls to select the combined letter by pressing the second wheel 113 or the third wheel 115 and to send the selected letter to the second display unit 145.

Also, in the Korean input mode, the controller 120 controls the scrolling or rotation speed of the displayed letters and words according to the user's manipulation speed of the first wheel 111, the second wheel 113, and the third wheel 115.

When the user rotates the first wheel 111, the second wheel 113, and the third wheel 115 fast, the controller 120 controls to rapidly rotate and enumerate the letters and the words in the display unit. When the user rotates the first wheel 111, the second wheel 113, and the third wheel 115 slow, the controller 120 controls to slowly rotate and enumerate the letters and the words in the display unit.

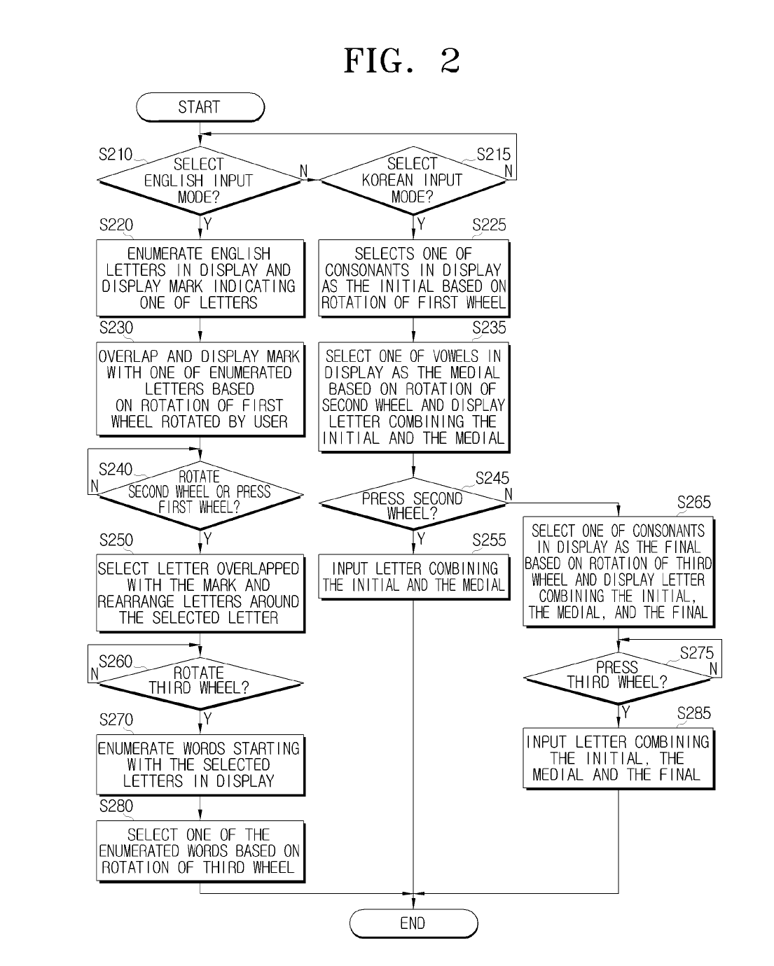

FIG. 2 is a flowchart of an input method according to an exemplary embodiment of the present invention.

The controller 120 determines whether the English input mode is selected (S210). In the English input mode (S210-Y), the controller 120 enumerates the English letters in the first display unit 141 and displays the mark indicating one of the letters (S220).

The controller 120 displays one of the enumerated letters overlapped by with the mark based on the rotation of the first wheel 111 rotated by the user (S230).

When one of the letters is overlapped by the mark, the controller 120 determines whether the user rotates the second wheel 113 or presses the first wheel 111 (S240).

When the user rotates the second wheel 113 or presses the first wheel 111 (S240-Y), the letter overlapped by the mark is selected and the letters around the selected letter are rearranged (S250).

Next, the controller 120 determines whether the third wheel 115 is rotated (S260). When the third wheel 115 is rotated, the words starting with the selected letters are enumerated in the first display unit 141 (S270).

The controller 120 selects one of the enumerated words based on the rotation of the third wheel 115 (S280).

When the English input mode is not selected (S210-N), the controller 120 determines whether the Korean input mode is selected (S215).

When the Korean input mode is selected (S215-Y), the controller 120 selects one of the consonants in the first display unit 141 as the initial based on the rotation of the first wheel 111 (S225).

Next, the controller 120 controls to select one of the vowels in the first display 141 as the medial based on the rotation of the second wheel 113 and to display the letter combining the initial and the medial (S235).

The controller 120 determines whether the second wheel 113 is pressed (S245). When the second wheel 113 is pressed, the controller 120 inputs the letter combining the initial and the medial (S255). When the second wheel 113 is not pressed, the controller 120 controls to select one of the consonants in the first display 141 as the final based on the rotation of the third wheel 115 and to display the letter combining the initial, the medial, and the final (S265).

Next, the controller 120 determines whether the third wheel 115 is pressed (S275). When the third wheel 115 is pressed (S275-Y), the controller 120 inputs the letter combining the initial, the medial, and the final (S285).

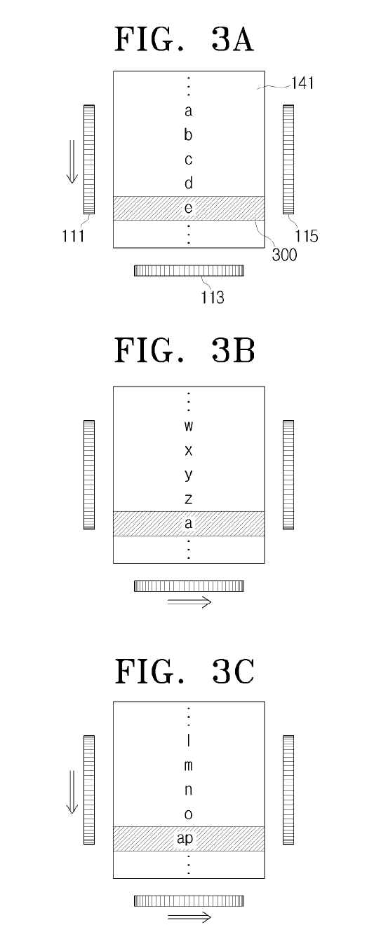

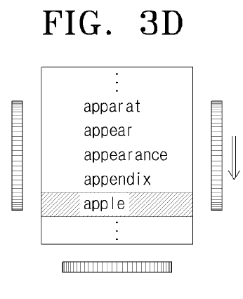

FIGS. 3A through 3D depict an English input method according to an exemplary embodiment of the present invention.

FIGS. 3A through 3D show the first wheel 111, the second wheel 113, the third wheel 115, a shadow area 300, and the first display unit 141. The screen of the first display unit 141 vertically enumerates the English letters, and the first wheel 111 and the third 115 are positioned to rotate in the same direction.

The second wheel 113 is positioned to rotate perpendicular to the first wheel 111 and the third wheel 115.

FIG. 3A shows the screen displayed when the first wheel 111 is manipulated.

After the English input mode is set through the mode input unit 117, when the first wheel 111 is manipulated, the English letters are enumerated vertically on the screen. By vertically rotating the first wheel 111, the user searches for an intended English letter.

FIG. 3B shows how to select the English letter in the shadow area 300 by manipulating the first wheel 111.

The user moves the intended English letter ‘a’ into the shadow area 300, horizontally rotates the second wheel 113, and then selects the English letter ‘a’ in the shadow area 300.

FIG. 3C shows how to select a next English letter by vertically rotating the first wheel 111 and horizontally rotating the second wheel 113.

Once the second wheel 113 is horizontally rotated as shown in FIG. 3B, the English letter ‘a’ in the shadow area 300 is selected and the English letters are vertically re-enumerated on the right side of the English letter ‘a’.

When the English letters are vertically re-enumerated on the right side of the English letter ‘a’, the user searches for an intended English letter by vertically rotating the first wheel 111.

As the first wheel 111 rotates vertically, the list of the English letters also moves vertically. The user prepares to select the English letter by moving the intended English letter ‘p’ into the shadow area 300.

FIG. 3D shows the selection of the intended word.

After the user selects the intended letters as shown in FIGS. 3A, 3B and 3C, once the third wheel 115 commences its vertical rotation, the English letters ‘app’ in the shadow area 300 are selected and the list of the English words starting with the English letters ‘app’ are enumerated vertically.

The user searches for the intended English word among the words starting with the English letters ‘app’ by rotating the third wheel 115 and selects the intended English word ‘apple’ by moving it into the shadow area 300.

As such, after one English letter is selected, the English word can be generated in the same manner. The second display 145 displays the generated word, and the user can send the generated word to the external video device by pressing the transmission input unit 119.

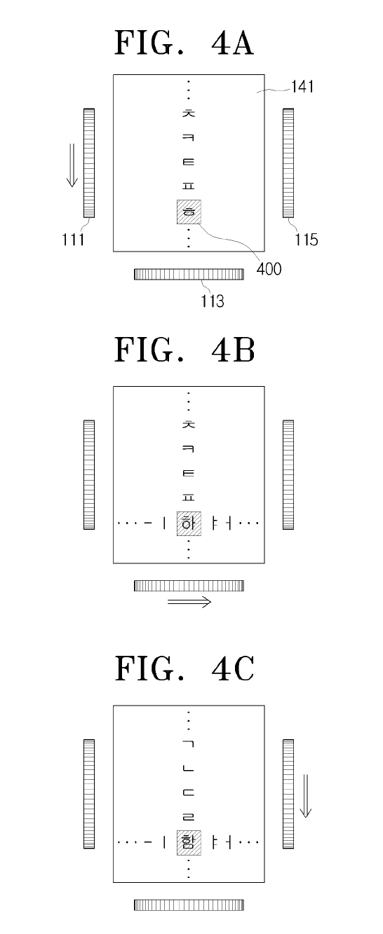

FIGS. 4A, 4B and 4C depict a Korean input method according to an exemplary embodiment of the present invention.

The first wheel 111, the second wheel 113, the third wheel 115, a shadow area 400, and the first display unit 141 are shown in FIGS. 4A, 4B and 4C. The screen of the first display unit 141 vertically enumerates Korean consonants, and the first wheel 111 and the third wheel 115 are positioned to rotate in the same direction.

The second wheel 113 is positioned to rotate perpendicular to the first wheel 111 and the third wheel 115.

FIG. 4A shows the screen displayed when the first wheel 111 is manipulated.

After the Korean input mode is set through the mode input unit 117, once the first wheel 111 is manipulated, the Korean consonants are vertically enumerated in the screen. By vertically rotating the first wheel 111, the user searches for the initial consonant [symbol] .

In doing so, it is possible to generate an ungrammatical character in view of the Korean notation by enumerating even consonants not allowed as the initial, or the fast and easy search can be conducted by enumerating only the consonants allowed as the initial.

FIG. 4B shows how to select the Korean consonant in the shadow area 400 by manipulating the first wheel 111 and to search for the Korean medial vowel by manipulating the second wheel 113.

Once the second wheel 113 is manipulated, the Korean vowels are enumerated horizontally in the screen. By horizontally rotating the second wheel 113, the user searches for his/her intended vowel [symbol] .

Likewise, it is possible to generate an ungrammatical character in view of the Korean notation by enumerating even vowels not allowed as the medial, or the fast and easy search can be conducted by enumerating only the vowels allowed as the medial.

If the user wants to select the Korean without the final, the user can select the character [symbol] by pressing the second wheel 113.

Before selecting the character [symbol] , the user can manipulate the first wheel 111 again.

When the user re-manipulates the first wheel 111, the Korean consonants are vertically enumerated in the screen. By vertically rotating the first wheel 111, the user can re-search for another intended initial, other than [symbol] .

In this case, with the pre-selected vowel [symbol] fixed in the screen, only the initial consonant is changed and combined with the medial vowel [symbol] in the screen.

After selecting the intended initial, the user can continue the Korean selection by manipulating the second wheel 113 or the third wheel 115.

FIG. 4C shows how to select the Korean vowel in the shadow area 400 by manipulating the second wheel 113 and to search for the Korean final consonant by manipulating the third wheel 115.

Once the third wheel 115 is manipulated, the Korean consonants are vertically arranged in the screen. By vertically rotating the third wheel 115, the user search for the intended consonant [symbol] .

Likewise, it is possible to generate an ungrammatical character in view of the Korean notation by enumerating even consonants not allowed as the final, or the fast and easy search can be conducted by enumerating only the consonants allowed as the final.

When the user presses the third wheel 115, the character [symbol] is selected. The word selected by pressing the third wheel 115 is shown in the second display unit 145.

When the second wheel 113, rather than the third wheel 115, is pressed even after arranging the character [symbol] , the character [symbol] is selected.

Before selecting the word [symbol] the user can re-manipulate the first wheel 111 and the second wheel 113.

If the user re-manipulates the first wheel 111, the Korean consonants are vertically arranged in the screen. By vertically rotating the first wheel 111, the user can re-search for the intended initial consonant other than [symbol] .

In this situation, with the pre-selected medial [symbol] and final [symbol] fixed in the screen, only the initial consonant is changed and combined with the medial vowel [symbol] and the final consonant [symbol] in the screen.

After selecting the intended initial, the user can continue the Korean selection by manipulating the second wheel 113 or the third wheel 115.

When the user re-manipulates the second wheel 113, the Korean vowels are horizontally arranged in the screen. By horizontally rotating the second wheel 113, the user can re-search for the intended medial other than [symbol] .

In this case, with the pre-selected initial [symbol] and final [symbol] fixed in the screen, only the medial vowel is changed and combined with the initial [symbol] and the final [symbol] in the screen. The fixation of the initial [symbol] and the final [symbol] signifies that they are not changed to other consonants, whereas the shapes and the positions of the initial consonant and the final consonant can be changed depending on the type and the position of the changed vowel.

After selecting the intended medial, the user can continue the Korean selection by manipulating the first wheel 111 or the third wheel 115.

As such, after one character is generated, a word can be generated in the same manner. The generated word is displayed in the second display unit 145, and the user can send the generated word to the external video device by pressing the transmission input unit 119.

So far, while the input apparatus and method for inputting the English letters and the Korean letters have been explained, letters other than English and Korean can be input.

While the remote controller is used as the letter input means, other input devices such as cellular phones, personal digital assistants (PDAs), and personal media players (PMPs) can input the letters.

While the first display unit and the second display unit are separately provided, the same display device can be divided into different areas or only one of the first display unit and the second display unit can be provided.

While the input letters are represented in the display unit of the user input apparatus, the letters can be represented in the display of the external video device. In this case, the user can manipulate the user input apparatus while watching the letter input screen of the external video device.

While the letters are input using up to three wheels, four or more wheels can be used to input the letters. In this case, the other wheels can be used for other purposes, for example, for the special characters.

While the first wheel and the third wheel are disposed vertically and the second wheel is disposed horizontally to ease the understanding, the first wheel, the second wheel, and the third wheel can be arranged in different directions.

While the rotational manipulation uses the wheels, any other rotational devices or rotational manipulations such as belt or touch pad can be employed.

To input the Korean letters, while the consonants are searched through the vertical rotation and the vowels are searched through the horizontal rotation, the consonants and the vowels can be searched in the opposite directions respectively.

While the user inputs the English word or the Korean word by selecting the English letters or the Korean letters through the wheel rotations, special letters than the English letters or the Korean letters can be selected and input. Also, the letter or the sentence, rather than the word, can be input.

As set forth above, the letters can be input based on the rotations of the user input apparatus. By inputting the letters in the differentiated manipulation not depending on the buttons, the diversity and the convenience in inputting the letters can be achieved.

Although a few exemplary embodiments of the present invention have been shown and described, it will be appreciated by those skilled in the art that changes may be made in the exemplary embodiments without departing from the principles and spirit of the invention, the scope of which is defined in the claims and their equivalents.

What is claimed is:

1. A user input apparatus comprising:
an input unit which is rotatable to input a plurality of letters of an enumeration type language; and
a controller which controls to display a mark overlapping one of the letters based on rotation of the first input unit.

2. The user input apparatus of claim 1, further comprising:
a first display unit which enumerates the letters and displays the mark overlapping the one of the letters,
wherein the input unit comprises a first input unit which is rotatable to scroll the letters enumerated by the first display.

3. The user input apparatus of claim 2, further comprising:
a second input unit which is rotatable,
wherein, if the second input unit is rotated, the controller controls to select the letter overlapped by the mark and to rearrange the letters in an area of the first display around the selected letter.

4. The user input apparatus of claim 3, further comprising:
a third input unit which is rotatable,
wherein, if the third input unit is rotated in a second direction, the controller controls to enumerate words including the selected letter in the first display.

5. The user input apparatus of claim 4, wherein the words start with the selected letter.

6. The user input apparatus of claim 4, wherein the controller controls to display the letters by distinguishing the selected letter from other letters which are not selected using at least one of a color, a size, a font, a underline, and a shadow.

7. The user input apparatus of claim 2, wherein if the first input unit is pressed, the controller controls to select the letter overlapped by the mark among the letters enumerated by the first display and to rearrange the letters around the selected letter in an area of the first display.

8. The user input apparatus of claim 7, wherein the first input unit comprises a wheel, and
if the wheel is pressed, the controller controls to display the selected letter in the first display.

9. The user input apparatus of claim 2, wherein the letters are vertically enumerated and scrolled in the first display.

10. The user input apparatus of claim 2, wherein the first input unit is rotatable in a direction which is the same as an enumeration direction of the letters.

11. The user input apparatus of claim 2, further comprising:
a transmission input unit which transmits a word or a sentence generated using the enumerated letters to an external device.

12. The user input apparatus of claim 2, further comprising:
a second display which displays a word or a sentence generated using the enumerated letters,
wherein the first display and the second display are positioned in different areas of one display device.

13. A user input method comprising:
inputting a plurality of letters of an enumeration type language displayed on a display unit by rotating an input unit; and
displaying on the display unit a mark overlapping one of the letters based on rotation of the input unit.

14. The user input method of claim 13, wherein the inputting the letters comprises:
if a first input unit of the input unit is rotated, scrolling the letters displayed by the display unit so that the letter overlapped by the mark changes, and
if a second input unit of the input unit is rotated, selecting the letter overlapped by the mark and rearranging the letters in an area around the selected letter on the display unit.

15. The user input method of claim 14, wherein the inputting the letters further comprises if a third input unit is rotated, enumerating words including the selected letter.

16. The user input method of claim 15, wherein the words start with the selected letter.

17. The user input method of claim 15, wherein the displaying operation distinguishes the selected letter from other letters which are not selected using at least one of a color, a size, a font, an underline, and a shadow.

18. The user input method of claim 13, wherein the inputting the letters further comprises if the first input unit is pressed, selecting a letter overlapped by the mark among the enumerated letters and rearranging the letters in an area around the selected letter.

19. The user input method of claim 18, wherein the inputting the letters further comprises the user presses a wheel of the first input means, displaying the at least one selected letter.

20. The user input method of claim 14, wherein the letters are vertically displayed and scrolled on the display unit.

21. The user input method of claim 14, wherein the first input unit is rotatable in a direction which is the same as an enumeration direction of the letters.

22. The user input method of claim 13, further comprising:
transmitting a word or a sentence generated by the inputting the letters to an external device.

23. The user input method of claim 13, further comprising:
displaying a word or a sentence generated by the inputting the letters on the display unit,
wherein the mark overlapping the one of the letters and the word or the sentence completed by arranging the input letters are positioned in different areas of the display unit.
